(19) United States
(12) Patent Application Publication
(10) Pub. No.: US 2005/0205694 A1
(43) Pub. Date: Sep. 22, 2005

(54) Ball component of ball and socket joint for directable water conduits

(75) Inventor: Chun Kong Li, Hong Kong (HK)

Correspondence Address: MICHAEL BEST & FRIEDRICH LLC, 401 NORTH MICHIGAN AVENUE, SUITE 1900, CHICAGO, IL, 60611-4212, US

(73) Assignee: Jing Mei Industrial Holdings Limited, Rarotonga (CK)

(21) Appl. No.: 10/805,818

(22) Filed: Mar. 22, 2004

(51) Int. Cl. B05B 15/08

(52) U.S. Cl. 239/587.4; 239/548; 239/587.1; 285/261

(57) ABSTRACT

A ball component for a ball and socket joint for a directable water conduit, comprising a ball, a collar integral with the ball and a passage extending through ball and collar; the ball and collar are made of plastics material and the component further includes a skirt that surrounds and is held on the collar. The skirt has a desired surface decoration.

### TECHNICAL FIELD

The present invention relates to a ball component of a ball and socket joint used in water ducting, for example to direct the outlet of a faucet or a showerhead.

Presently, the ball component of a ball and socket joint for a showerhead is traditionally made from metal, which can be finished to any desired finish, e.g. with a chromium, brass or gold finish, to match other metal fittings within the bathroom. Although it is possible to make the ball component out of molded plastics, it would then not generally match the other metal fittings in the bathroom and can look out of place. However, the cost of making the ball component out of metal is relatively high and is much cheaper to make it of plastics material.

### DISCLOSURE OF INVENTION

According to the present invention, there is provided a ball component of a ball and socket joint for a water conduit, comprising a ball, a collar secured to the ball and a passage extending through ball and collar, the improvement being that the ball and collar are made of plastics material and the component further includes a skirt that surrounds and is held on the collar.

The ball and collar are preferably integral, that is to say made in one piece.

By making the ball and collar out of molded plastic material, the overall cost of the component is substantially reduced and, since the plastics material of the collar is covered by the skirt, the plastics material is not evident. In addition, the skirt can be provided in a variety of different finishes to provide the required design and hence only one design of ball component needs to be made; although a range of skirts will be needed for the various designs and finishes required, it is much cheaper to make a range of skirts to the different designs rather than making a range of complete ball components to the different designs.

The collar may include a connector, e.g. an internal screw thread, for connecting the ball component to a water inlet joint or other plumbing component.

The component preferably also includes a coupling for joining the collar and the skirt together. The coupling can comprise a protrusion provided on the outside of the collar that engages with the skirt, e.g. by providing a corresponding recess in the inner surface of the skirt; the protrusion and the skirt engage with each other when the skirt has been placed around the collar to keep the skirt in place around the collar. The protrusions may take the form of ribs and the recesses may take the form of grooves. Obviously, the opposite arrangement is possible, that is to say the protrusion can instead be provided on the inside surface of the skirt and the recess on the outside surface of the collar. Such an arrangement provides a snap-fit to easily engage the skirt on the collar. Preferred, however, is an arrangement in which protrusions are provided on the outside of the collar engage the top rim of the skirt to hold it in place. Alternatively, one or more through holes may be provided that extend through the skirt and engage with corresponding protrusions on the outside surface of the collar.

The present invention also provides a ball and socket joint for a directable water conduit that includes the ball component held within a socket.

### DETAILED DESCRIPTION OF THE DRAWINGS

FIG. 1 shows a sectional view through a prior art ball and socket joint for a showerhead;

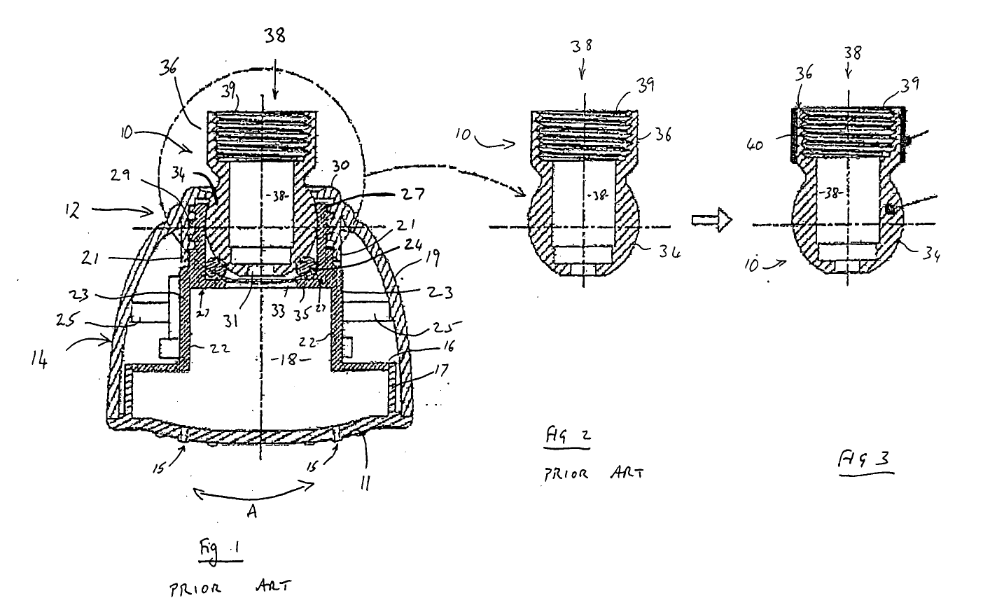

FIG. 2 is an enlarged sectional view of the prior art ball component of the showerhead of FIG. 1;

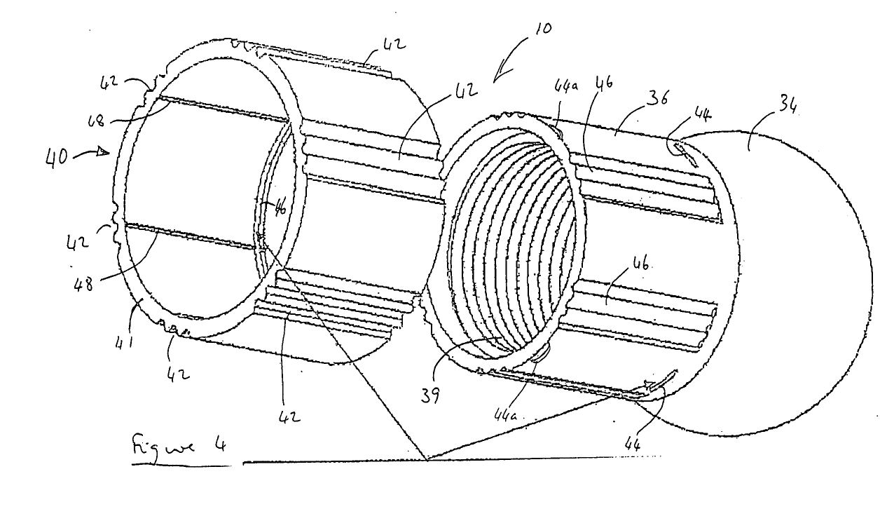

FIG. 3 is a sectional view showing the ball component according to the present invention; and

FIG. 4 is an exploded perspective view of the ball component of FIG. 3.

### BEST MODE OF PUTTING THE INVENTION INTO OPERATION

FIGS. 1 and 2 depict a directable showerhead 14 according to the prior art. It includes, in addition to the showerhead 14, a ball component 10 and a socket 12 that cooperates with the ball component 10 to form a ball and socket joint that can be used for directing the showerhead 14 in a desired direction.

The ball component 10 is made as a single piece and has a ball 34 and a collar 36; the ball 34 is seated in the socket 12, as shown in FIG. 1. A passage 38 is provided through the ball component 10, that is to say through the ball 34 and the collar 36. The passage 38 extends from an opening 31 provided in the ball 34 to an end in the collar 26 provided with a screw thread 39.

The ball component 10 is machined out of a single piece of plastic and is provided with a finish to match the outer surface of the showerhead 14, e.g. by electroplating the ball component.

As mentioned, one end of the passage 38 has an internal screw thread 39; a suitable joint of known design having a mating screw thread (not shown) can be screwed into the threaded end 39 of the passage 38 to connect a conduit (not shown) to the ball component 10 to provide a water supply to the passage 38 and from thence to the showerhead 14. The joint having the mating screw thread (not shown) can be secured to the wall of a shower cubicle, thereby anchoring the showerhead 14 to the wall.

The socket 12, which forms part of the showerhead 14, can rotate pivot about the ball component 10, as shown by arrows A, so that the showerhead can be directed in a desired direction. The rotational movement of the showerhead 14 is limited when the ball component 10 engages the rim 30 of the showerhead.

The showerhead 14 includes a housing 19 and a faceplate 11. The face plate 11 has openings 15 for forming shower jets; these openings can be of any design known in the art. The housing 19 can have any desired decorative finish. For example, it can be made of plastic or can be made of metal having a chrome, brass or gold finish.

The housing 19 has a flange 21 within the showerhead 14 that depends from the rim 30 and that has an internal screw thread. The faceplate 11 is connected to a channel member 23 having cylindrical walls 16,17,22, 27; wall 27 is provided with a corresponding external screw thread, which is screwed onto the screw thread of the flange 21. Suitable seals may be provided to prevent water leaking through the screw thread. The channel member 23 is located centrally within the housing 19 by means of spacers 25 that engage the inner wall of the housing 19.

The faceplate 11 and the walls 16,17,22 of the channel member 23 define between them a chamber 18, for receiving water from the channel 38.

The socket 12, in which the ball component 10 is seated, is formed by the cylindrical wall 27 at the upper part of the channel member 23; which has a smooth cylindrical internal face of a diameter just larger than that of the ball 34. At the lower end of the cylindrical wall 27, the channel member 23 has an inwardly extending annular ridge 35 having an aperture 33 in register with the opening 31 at the end of the channel 38 in the ball component. An O-ring 24 is seated on the ridge 35 and forms a seal between the ball 34 and the channel member 23. The ball 34 is held within the wall 27 by the rim 30 of the housing 30. The rim 30 has a diameter that is smaller than the widest diameter of the ball 34 and so prevents the ball being pulled out of the socket. Indeed, the rim 30 urges the ball 34 against the resilient O-ring 24 within the socket, thereby improving the water seal between the chamber 18 and the ball 34. In addition, friction between the O-ring 24 and the ball 34 keeps the showerhead pointing in the direction set by the user.

In operation, water is supplied to the chamber 18 through the channel 38 in the ball component 10 and through the opening 31 and the aperture 33 and is thoroughly mixed in the chamber 18. The water pressure in chamber 18 forces the water though the jet openings 15 in the faceplate 11 to form shower jets. Because of the mixing of the water in the chamber 18, the water exiting the jet openings 15 is consistently of the required temperature.

Referring now to FIG. 3, a ball component 10 according to the present invention is shown that is identical to that shown in FIG. 2 except that the ball and collar 34 and 36 are molded out of plastics material and that the ball component includes an annular metal skirt 40. Any one of a large number of plastic materials may be used to form the ball and collar so long as it is able to resist the wear of the ball component by repeated swiveling of the showerhead, as shown by arrows A in FIG. 1. The preferred material is an acetal polymer and the ball and collar 34,36 are preferably integral with each other and made by a single injection molding operation.

The annular metal skirt 40 fits over the collar 36 of the ball component to provide the required surface finish, i.e. to match the external finish of the housing 19, as will be described in further detail by reference to FIG. 4.

FIG. 4 shows the ball component 10, including the ball 34 and the collar 36, provided with an internal screw thread 39. The metal skirt 40 has the desired surface decoration, e.g. flutes 42, and is made of a simple ring of brass or other material having the desired surface finish; if necessary, the skirt 40 can be electroplated to the desired surface finish, e.g. chrome, gold or brass with the required luster.

The internal diameter of the skirt 40 is just larger than the external diameter of the collar 36 so that it can fit snugly over the collar. Around the base of the collar there are provided button projections 44 (four are provided and only two are visible in FIG. 4 but any number may be provided) and around the base of the internal face of the skirt 40 an annular groove 46 is provided that can engage the button projections 44 to provide a snap-fit engagement between the collar and the skirt, thereby keeping the skirt in place around the collar. Alternatively, the button projections can be provided at the top of the collar, as indicated by the reference numbers 44a, over which the skirt 40 can be pushed and that can engage the top rim 41 of the skirt to retain the skirt in place.

As shown in FIG. 4, the collar 36 also includes flutes 46 that provide surface decoration in case the skirt 40 is not used. In addition, the inside face of the skirt 40 includes ribs 48 that engage with the flutes 46 to prevent the skirt 40 from rotating around the collar 36. However, the skirt need not be secured to the collar so long as it is held on the collar; for example, the skirt could rotate around the collar, as is the case with the arrangement shown in FIG. 4, where the engagement of the button projections 44 in the groove 46 allow the skirt to rotate on the collar while holding it from moving in the axial direction on the collar.

An advantage of the present invention is that it substantially reduces the cost of the ball component by making the ball and collar as a single molded plastic piece, while at the same time providing the decorative finish required by means of the skirt 40. The cost of molding the ball and collar and of manufacturing the skirt is considerably less than the cost that of machining the ball and collar out of brass or other metal required for the desired surface finish, especially when the skirt is a simple unfluted cylinder.

It will be appreciated that numerous variations within the embodiment described are feasible. In particular, the flute arrangement 46 on the collar may be dispensed with. Furthermore, other arrangements for engaging the skirt 40 on the collar 36 can also be provided, for example a screw thread; alternatively, the relative diameters of the collar 36 and the skirt 40 may be such that the skirt can be pushed onto the collar 36 and retained in place by friction.

While the invention has been described according to what is presently considered to be the most practical and preferred embodiment, it must be understood that the invention is not limited to the disclosed embodiment. Those ordinarily skilled in the art will understand that various modifications and equivalent structures and functions may be made without departing from the spirit and scope of the invention as defined in the claims. Therefore, the invention as defined in the claims must be accorded the broadest possible interpretation so as to encompass all such modifications and equivalent structures and functions.

1. In a ball component for ball and socket joint for a water conduit, comprising a ball, a collar integral with said ball and a passage extending through ball and collar, the improvement being that said ball and collar are made of plastics material and said ball component further includes a skirt that surrounds and is held on to said collar.

2. A ball component as claimed in claim 1, wherein said collar and said skirt each has an outer face having a surface finish and the surface finish of said collar is different to the surface finish of said skirt.

3. A ball component as claimed in claim 1 wherein said collar, includes a coupling for connecting said ball component to another plumbing component.

4. A ball component as claimed in claim 3, wherein said coupling is a screw thread.

5. A ball component as claimed in claim 1, which further includes a connector for joining said collar and said skirt together,

6. A ball component as claimed in claim 5, wherein said connector comprises a protrusion provided on said collar that engages said skirt when said skirt has been placed around said collar.

7. A ball component as claimed in claim 6, wherein said connector is a snap connector.

8. A ball component as claimed in claim 5, wherein said connector comprises a protrusion provided on said skirt and a corresponding recess in said collar such that said protrusion and said recess engage with each other when said skirt has been placed around said collar.

9. A ball component as claimed in claim 8, wherein said connector is a snap connector.

10. A ball component as claimed in claim 1, which includes an engagement between said collar and said skirt, the engagement comprising at least one rib provided on one of said collar and said skirt and at least one groove for engaging said at least one rib provided on the other of said collar and said skirt.

11. A ball component as claimed in claim 1, wherein said skirt is made of metal.

12. A ball component as claimed in claim 11, wherein said metallic skirt is electroplated.

13. A ball and socket joint for a directable water conduit that comprises
a) a ball component comprising:
a ball,
a collar integral with said ball
a passage extending through said ball and collar, and
a skirt that surrounds and is held on to said collar
wherein said ball and collar are made of plastics material and
b) a socket in which said ball is seated.

14. A directable water conduit that comprises
a) a ball component that comprising:
a ball,
a collar integral with said ball,
a passage extending through ball and collar,
a skirt that surrounds and is held on said collar,
wherein said ball and collar are made of plastics material,
b) a socket in which said ball is seated, and
c) a water outlet device connected to said socket.

15. A directable water conduit as claimed in claim 14, wherein said water outlet device is a showerhead.
